(19) United States
(12) Patent Application Publication
(10) Pub. No.: US 2003/0212235 A1
(43) Pub. Date: Nov. 13, 2003

(54) Reactive hot melt adhesive

(76) Inventors: James W. Nowicki, Hopewell, NJ (US); Daniel T. Rumack, Randolph, NJ (US)

Correspondence Address: Charles W. Almer, Counsel I.P., NATIONAL STARCH AND CHEMICAL COMPANY, 10 Finderne Avenue, Bridgewater, NJ, 08807-0500, US

(21) Appl. No.: 10/463,914

(22) Filed: Jun. 17, 2003

Related U.S. Application Data
(63) Continuation-in-part of application No. 09/901,226, filed on Jul. 9, 2001.

(51) Int. Cl. C08G 18/00

(52) U.S. Cl. 528/44

(57) ABSTRACT

A reactive polyurethane hot melt adhesive having improved adhesion to wood contains a polymeric isocyanate.

### FIELD OF THE INVENTION

The invention relates to hot melt adhesives, in particular reactive hot melt adhesives having good adhesion to wood.

### BACKGROUND OF THE INVENTION

Hot melt adhesives are solid at room temperature but, upon application of heat, melt to a liquid or fluid state in which form they are applied to a substrate. On cooling, the adhesive regains its solid form. The hard phase(s) formed upon cooling the adhesive imparts all of the cohesion (strength, toughness, creep and heat resistance) to the final adhesive. Curable hot melt adhesives, which are also applied in molten form, cool to solidify and subsequently cure by a chemical crosslinking reaction. An advantage of hot melt curable adhesives over traditional liquid curing adhesives is (1) their ability to provide “green strength” upon cooling prior to cure and (2) provide adhesives of very low crosslinking density and thus high levels of flexibility and toughness.

The majority of reactive hot melts are moisture-curing urethane adhesives. These adhesives consist primarily of isocyanate terminated polyurethane prepolymers that react with surface or ambient moisture in order to chain-extend, forming a new polyurethane polymer. Polyurethane prepolymers are conventionally obtained by reacting diols with diisocyanates. Pure diols are favored for use, instead of polyols with higher functionality, to avoid excessive branching that can lead to poor pot stability. Methylene bisphenyl diisocyanate (MDI) is favored over lower molecular weight isocyanates to minimize volatility. Cure is obtained through the diffusion of moisture from the atmosphere or the substrates into the adhesive, and subsequent reaction. The reaction of moisture with residual isocyanate forms carbamic acid. This acid is unstable, decomposing into an amine and carbon dioxide. The amine reacts rapidly with isocyanate to form a urea. The final adhesive product is a lightly crosslinked material held together primarily through hydrogen bonding, urea groups and urethane groups.

The prior art discloses that that the performance of reactive hot melt adhesives for most applications may be substantially improved by the incorporation of acrylic polymers into conventional polyurethane adhesives, in particular reactive hydroxy-containing and non-reactive acrylic copolymers. Improvement in green strength may be obtained by adding higher molecular weight polymers (reactive or not) and/or incorporating crystalline diols, most commonly polyester diols. Reactive hot melt adhesives containing acrylic polymers are known to have low isocyanate indices. For example, U.S. Pat. No. 5,021,507 issued to Stanley et al. discloses such adhesives having an isocyanate index between one and two. Such a low isocyanate index allows for a reduction in the level of free isocyanate content in the final hot melt adhesive composition to less than 4% and preferably less than 1%.

These prior art adhesives are extremely tough, with outstanding low temperature flexibility, heat and chemical resistance, and specific adhesion to polar substrates. Adhesion to a wide range of other substrates may be obtained through the addition of adhesion promoters such as silane coupling agents. Despite these advances in the art, there remains a need for improvements in reactive hot melt technology to expand the application of such adhesives and their effectiveness in such applications. The present invention addresses this need.

### SUMMARY OF THE INVENTION

The invention provides a moisture curable reactive hot melt adhesive having good adhesion to wood.

One aspect of the invention is directed to an adhesive composition comprising a blend of a polyurethane hot melt and a polymeric isocyanate. The polyurethane hot melt component will typically comprise a polyester polyol, a polyether polyol, and/or hydroxyl-functional acrylic polymer, and may also include a non-functional acrylic polymer. A preferred polymeric isocyanate for use in the practice of the invention is polymeric methylenebisphenyldiisocyanate (MDI).

Another aspect of the invention is directed to a process for preparing a reactive hot melt adhesive comprising reacting at least one polyol with a monomeric isocyanate at a temperature of from about 250 to 275° F., and adding to the reaction mixture a polymeric isocyanate, preferably polymeric MDI. The preferred monomeric isocyanate-containing compound is MDI. The polyols used include polyether, polyester and/or hydroxy-functional polymers. Non-functional acrylic can be added, if desired. In a preferred embodiment, the polymeric isocyanate is added following completion of the reaction of the polyol and the monomeric isocyanate. Polymeric MDI is preferred for use in the practice of the invention.

Still another aspect of the invention is directed to a method of improving the adhesion of a polyurethane adhesive to wood comprising adding an effective amount of an polymeric isocyanate, preferably polymeric MDI, to a polyurethane reactive hot melt adhesive formulation.

Yet another aspect of the invention is directed to a method for bonding materials together which comprises applying the adhesive composition of the invention in a molten form to a first substrate, bringing a second substrate in contact with the composition applied to the first substrate, and subjecting the applied composition to conditions which will allow the composition to cool and cure to an irreversible solid form, said conditions comprising moisture. In a preferred embodiment, at least one of said first substrate or said second substrate comprises wood.

Also encompassed by the invention is an article of manufacture comprising the adhesive of the invention.

### DETAILED DESCRIPTION OF THE INVENTION

The disclosures of all documents cited herein are incorporated in their entireties by reference.

All percents are percent by weight of the adhesive composition, unless otherwise stated.

Throughout this disclosure, use of the terms “isocyanate,” “diisocyanate,” “polyisocyanate,” “MDI” and the like, in the absence of the term “polymeric”, means the compound is in the monomeric form conventionally used in the art to prepare polyurethane reactive hot melt adhesive compositions.

It has now been discovered that the addition of a polymeric isocyanate to a polyurethane hot melt adhesive improves adhesion to natural and synthetic substrates wherein at least one of the substrates contains at least one active hydrogen. Among the natural substrates to which adhesive is especially useful are wood, cellulose, lignin, collagen and protein. Use of the term wood encompasses wood-containing composites. Examples of synthetic substrates for which the adhesive is especially advantageous are phenolic, cured epoxy, polyamides and polyesters.

Preferred polyurethane hot melt formulations will typically comprise from about 5 to about 50% by weight of an isocyanate, a polyol mixture comprising from about 10 to about 60% of a polyether, from about 0 to about 40% of a polyester and from about 0 to about 50% of a hydroxyl-functional acrylic resin, and from about 0 to about 50% of a non-reactive acrylic resin.

Polymeric isocyanates which may be used in the practice of the invention are aromatic or aliphatic, more preferable aromatic isocyanate oligomers having 2 or more, preferably 2-10 repeating units, which have an isocyanate functionality of 2 or more, preferably between about 2 and about 3. A preferred polymeric isocyanate is polymeric MDI. Non-limiting examples include Rubinate 1820, a polymeric MDI available from Huntsman and Mondur MR, a polymeric MDI available from Bayer. The polymeric isocyanate is added in an amount effective to improve adhesive to wood. Typically amounts of from about 1 to about 20% will be used, more typically from about 1% to about 10%.

The moisture curable, hot melt polyurethane adhesives of the invention may be prepared through the reaction of a mixture of polyols with an isocyanate-containing compound at a temperature of from about 250° F. to about 275° F. Polymeric isocyanate is preferably added after the reaction is substantially complete, but may also be added prior to completion of the reaction. The resulting adhesive comprises a blend of a polyurethane hot melt and polymeric isocyanate.

The urethane prepolymers which can be used to prepare the adhesives of the invention are those conventionally used in the production of polyurethane hot melt adhesive compositions. Any suitable compound which contains two or more isocyanate groups may be used for preparing the urethane prepolymers. Typically from about 5 to about 25 parts by weight of an isocyanate is used.

Organic polyisocyanate which may be used to practice the invention include alkylene diisocyanates, cycloalkylene diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′, 5, 5-tetratetraisocyanate, and the like. While such compounds are commercially available, methods for synthesizing such compounds are well known in the art. Preferred isocyanate-containing compounds are methylenebisphenyldiisocyanate (MDI), isophoronediisocyanate (IPDI) and toluene diisocyanate (TDI).

Most commonly, the prepolymer is prepared by the polymerization of a polyisocyanate with a polyol, most preferably the polymerization of a diisocyanate with a diol. The polyols used include polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, as well as mixtures thereof. The polyol is typically used in an amount of between about 1 to about 70 parts by weight.

Examples of polyether polyols include a linear and/or branched polyether having plural numbers of ether bondings and at least two hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine; with at least one compound selected from the group consisting of ethylene oxide, propylene oxide and butylene oxide.

Polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis-(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred polycarboxylic acids are the aliphatic and cycloaliphatic dicarboxylic acids containing no more than 14 carbon atoms and the aromatic dicarboxylic acids containing no more than 14 atoms.

Commercially available polyols which may be used in the practice of the invention include polyethers such as ARCOL PPG 2025 (Bayer), PolyG 20-56 (Arch) and Pluracol P-2010 (BASF), polyesters such as Dynacoll 7360 (Creanova), Fomrez 66-32 (Crompton) and Rucoflex S-105-30 (Bayer) and polybutadiene such as PolyBD R-45HTLO (Elf Atochem).

In addition, the urethane prepolymers may be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above. In accordance with one embodiment of the invention, the hydroxyl containing acrylic polymer may function as the polyol component, in which case, no additional polyol need be added to the reaction.

Further, small amounts of low molecular weight dihydroxy, diamino, or amino hydroxy compounds may be used such as saturated and unsaturated glycols, e.g., ethylene glycol or condensates thereof such as diethylene glycol, triethylene glycol, and the like; ethylene diamine, hexamethylene diamine and the like; ethanolamine, propanolamine, N-methyldiethanolamine and the like.

When an acrylic component (functional or not) is desired to be added, the total acrylic content will typically be in the range of from about 2 to about 60%.

Virtually any ethylenically unsaturated monomer containing a functionality greater than one may be utilized in the compositions of the present invention. Functional monomers include, without limitation acid, hydroxy, amine, isocyanate, and thio functional monomers. Hydroxyl functionality is preferred and is described in detail herein.

Most commonly employed are hydroxyl substituted C₁ to C₁₂ esters of acrylic and methacrylic acids including, but not limited to hydroxyl substituted methyl acrylate, ethyl acrylate, n-butyl acrylate, 2-ethylhexyl acrylate, isobutyl acrylate, n-propyl or iso-propyl acrylate or the corresponding methacrylates. Mixtures of compatible (meth)acrylate monomers may also be used. Additional monomers that may be used include the hydroxyl substituted vinyl esters (vinyl acetate and vinyl propionate), vinyl ethers, fumarates, maleates, styrene, acrylonitrile, etc. as well as comonomers thereof.

These monomers may blended with other copolymerizable comonomers as formulated so as to have a wide range of Tg values, as between about −48° C. and 105° C., preferably 15° C. to 85° C. Suitable comonomers include the C, to C₁₂ esters of acrylic and methacrylic acids including, but not limited to methyl acrylate, ethyl acrylate, n-butyl acrylate, isobutyl acrylate, 2-ethylhexyl acrylate, n-propyl or iso-propyl acrylate or the corresponding methacrylates. Mixtures of compatible (meth)acrylate monomers may also be used. Additional monomers that may be used include the vinyl esters (vinyl acetate and vinyl propionate), vinyl ethers, fumarates, maleates, styrene, acrylonitrile, ethylene, etc. as well as comonomers thereof. The hydroxyl containing monomers may be the same or different from the monomers used in the remainder of the acrylic polymerization. The particular monomers selected will depend, in large part, upon the end use for which the adhesives are intended. Thus, adhesives to be used in pressure sensitive applications or in applications wherein adhesion to metal is required will be selected to obtain a lower Tg polymer than may be desired in non-pressure sensitive applications or those involving more easily bonded substrates.

When the adhesive is to be prepared utilizing monomeric materials, the respective monomers may be added to the polyols and polymerized therein prior to formation of the prepolymer or may be added to the already formed prepolymer and the acrylic polymerization subsequently performed. In the case of polyamino or polymercapto containing prepolymers, in-situ vinylic polymerization must be performed only in the pre-formed prepolymer.

The hydroxyl containing ethylenically unsaturated monomer is polymerized using conventional free radical polymerization procedures to a relatively low molecular weight. For purposes of clarification, use of the term “low molecular weight” means number average molecular weights in the range of approximately 2,000 to 50,000, preferably 5,000 to 30,000. Molecular weight distribution is characterized by Gel Permeation Chromatography using a PL Gel, Mixed 10 micron column, a Shimadzu Model RID 6A Detector with a tetrahydrofuran carrier solvent at a flow rate of 1 milliliter per minute. The low molecular weight is obtained by careful monitoring and controlling the reaction conditions and, generally, by carrying out the reaction in the presence of a chain transfer agent such as dodecyl mercaptan. Subsequent to the polymerization of the ethylenically unsaturated monomer(s), the polyisocyanate and any additional ingredients required for the urethane prepolymer forming reaction are added and that reaction is carried out using conventional condensation polymerization procedures. In this manner, the resultant isocyanate terminated urethane prepolymer forms the reactive curing hot melt adhesive described above which contains about 2 to about 50% of the low molecular weight hydroxyl containing polymer.

It is also possible to polymerize the low molecular weight polymer in the presence of the already formed isocyanate terminated urethane prepolymer. This method has the drawback of subjecting the prepolymer to unnecessary heating during the acrylic polymerization, heating that might result in branching, viscosity increase, depletion of needed isocyanate groups and possible gellation. Although these disadvantages are subject to control, more stringent control of conditions are required as compared to polymerization in the non-isocyanate functional urethane components. When the reaction is run in the polyol or other non-isocyanate containing component, there is also the advantage of lower reaction viscosities and reduced exposure to isocyanate vapors because of the lesser amount of heating required.

Optionally, the hydroxyl containing functionality may be introduced into the adhesive in the form of pre-polymerized low molecular weight hydroxyl containing polymers. In the latter case, typical polymers include hydroxyl substituted butyl acrylate, hydroxylated butyl acrylate/methyl methacrylate copolymers, hydroxylated ethyl acrylate/methyl methacrylate copolymers, and the like. Preferred polymers have a number average molecular weight of 5,000 to 30,000 and a hydroxyl number of 4 to 30. If used in the form of low molecular weight polymers, the polymers may be blended with the polyol prior to reaction thereof with the isocyanate or they may be added directly to the isocyanate terminated prepolymer.

While the adhesives may be used directly as described above, if desired the adhesives of the present invention may also be formulated with conventional additives which are compatible with the composition. Such additives include plasticizers, compatible tackifiers, catalysts, fillers, anti-oxidants, pigments, adhesion promoters, stabilizers and the like. Conventional additives which are compatible with a composition according to this invention may simply be determined by combining a potential additive with the composition and determining if they are compatible. An additive is compatible if it is homogenous within the product.

The reactive hot melt adhesives of the invention may also contain flame retardant components. Fire retardant additives known in the art for imparting flame resistance to polyurethane compositions may be added. Such compounds include inorganic compounds such as a boron compound, aluminum hydroxide, antimony trioxide and the like, and other halogen compounds including halogen-containing phosphate compounds such as tris(chloroethyl)phosphate, tris(2,3-dichloropropyl)-phosphate, and the like. These and other flame retarding compositions are described in U.S. Pat. Nos. 3,773,695 4,266,042, 4,585,806, 4,587,273 and 4849467, and European Patent No. 0 587 942. In a preferred embodiment, ethylenebistetrabromophthalimide and/or tris(2,3-dibromopropyl)-isocyanurate is added as a prime flame retardant component. The ethylenebistetrabromophthalimide and/or tris(2,3-dibromopropyl)isocyanurate may be used with or without other flame retardants. The composition may further comprise a chlorinated paraffin and/or an aryl phosphate ester as a further flame retardant component. The optional chlorinated paraffin imparts flame retardancy as well as performing as a viscosity modifier. The aryl phosphate ester further imparts improved adhesion to the substrates. The flame retardant polyurethane-based reactive hot melt adhesives when used in the practice of the invention gives excellent flame retardancy while maintaining the targeted properties of the base polymer, such as good green strength, controlled setting speed and good thermal stability at elevated temperatures.

This invention also provides a method for bonding articles together which comprises applying the reactive hot melt adhesive composition of the invention in a liquid melt form to a first article, bringing a second article in contact with the composition applied to the first article, and subjecting the applied composition to conditions which will allow the composition to cool and cure to a composition having an irreversible solid form, said conditions comprising moisture. The composition is typically distributed and stored in its solid form, and is stored in the absence of moisture. When the composition is ready for use, the solid is heated and melted prior to application. Thus, this invention includes reactive polyurethane hot melt adhesive compositions in both its solid form, as it is typically to be stored and distributed, and its liquid (i.e., molten), form, after it has been melted, just prior to its application.

After application, to adhere articles together, the reactive hot melt adhesive composition is subjected to conditions that will allow it to solidify and cure to a composition that has an irreversible solid form. Solidification (setting) occurs when the liquid melt is subjected to room temperature. Curing, i.e. chain extending, to a composition that has an irreversible solid form, takes place in the presence of ambient moisture.

As used herein, “irreversible solid form” means a solid form comprising polyurethane polymers extended from the aforementioned polyurethane prepolymers. The composition having the irreversible solid form typically can withstand temperatures of up to 150° C. Using ethylenebistetrabromophthalimide as a flame retardant, the thermal stability of the irreversible solid can be improved.

While the reactive hot melt composition of the invention is useful for bonding articles composed of a wide variety of substrates (materials), including but not limited to wood, metal glass and textiles, the adhesive of the invention is particularly useful in bonding together substrates in which one or both substrates is made of wood or a wood-containing composite. Non-limiting examples include use in laminating such as in sidewall panels, office partitions, and structural insulated panels, for use in veneering such as in floors and furniture, millwork, speaker assembly, as a glazing/backbedding compound, in appliance assembly, in furniture assemble and in the manufacture of doors, including entry doors, garage doors, and the like.

The invention is further illustrated by the following non-limiting examples.

### EXAMPLES

In the Examples, viscosity was measured using a Brookfield Viscometer with Thermosel heating unit, spindle 27. Cured bond performance (block shear and % wood tear) at room temperature and elevated pressure soak and boil was evaluated using samples (pine to pine) prepared and fully cured for 7 days in accordance with ASTM D31 10.

### Example 1

Reactive hot melt adhesives having the formulations shown in Table 1 (% by weight) were prepared. All the polyols and acrylic polymers (reactive or not) were added to melt and mix under vacuum until homogeneous and free of moisture. Then MDI was added and polymerization allowed to proceed with mixing under vacuum until reaction is complete. Polymeric MDI was then added. The resulting pre-polymer was then placed into a container under a dry nitrogen headspace to prevent exposure to moisture.

TABLE 1

| Material | Sample A | Sample B | Sample C | Sample D |
|---|---|---|---|---|
| PPG 1025 | 34.75 | 33.00 | 32.15 | 31.25 |
| ELVACITE 2013 | 28.55 | 27.15 | 26.40 | 25.70 |
| DYNACOLL 7360 | 20.10 | 19.10 | 18.60 | 18.10 |
| MODAFLOW | 0.10 | 0.10 | 0.10 | 0.10 |
| MONDUR M | 16.50 | 15.65 | 15.25 | 14.85 |
| MONDUR MR | 0 | 5.0 | 7.5 | 10.0 |

PPG 1025 (a 1000 MW polyether polyol - available from Bayer)
Dynacoll 7360 (a 3750 MW hexanediol adipate available from Creanova)
ELVACITE 2013 (a 80° C. Tg/50,000 Mw acrylic - available from Ineos)
MODAFLOW (an acrylic defoamer available from Solutia)
MONDUR M (4, 4′ MDI available from Bayer)
MONDUR MR (polymeric 4, 4′ MDI available from Bayer)

Adhesive properties of Samples A-D are shown in Table 2. Wood tear, as a function of surface area, was visually observed and evaluated in accordance with ASTM D31 10. The number reported in Table 2 is the average of 5 tests.

TABLE 2

| Formulation | % Mondur MR | Block Shear (psi) | % Wood Tear |
|---|---|---|---|
| Sample A | 0 | 1125 | 31 |
| Sample B | 5.0 | 1394 | 68 |
| Sample C | 7.5 | 1728 | 95 |
| Sample D | 10.0 | 1509 | 94 |

Increasing Mondur MR levels up to 7.5% result in an increase in the shear strength as well as the amount of observed substrate failure.

### Example 2

In addition to room temperature block shear testing, parts bonded with Sample D and a viscosity modified Sample D (Sample D′), modified by the incorporation of additional monomeric MDI than used in the preparation of Sample D, was subjected to pressure soak and boil conditions. These formulations are compared in Table 3.

TABLE 3

| | Room Temp. | Pressure Soak | Boil |
|---|---|---|---|
| | Block Shear | Block Shear | Block Shear |
| | (psi/% | (psi/% | (psi/% |
| Formulation | Wood Tear) | Wood Tear) | Wood Tear) |
| Sample D | 1711 psi/95% | 810 psi/66% | 536 psi/18% |
| Sample D′ | 1680 psi/87% | 845 psi/94% | 547 psi/64% |
| (low viscosity modified) | | | |

With approximately 10% Mondur MR, high wood tear values are achievable even for the pressure soak and boil tests.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A reactive hot melt adhesive comprising a blend of a polyurethane hot melt and a polymeric isocyanate, wherein the adhesive is used to bond two substrates and wherein at least one of the substrates contains at least one active hydrogen.

2. The adhesive of claim 1 wherein the substrate containing at least one active hydrogen comprises a synthetic material or a natural material.

3. The adhesive of claim 2 wherein the natural material comprises wood, cellulose, protein, collagen or lignin.

4. The adhesive of claim 2 wherein the synthetic material comprises phenolic, cured epoxy, polyamides and polyesters.

5. The adhesive of claim 1 wherein the polymeric isocyanate is polymeric MDI.

6. The adhesive of claim 1 wherein the polyurethane hot melt comprises a functional acrylic polymer and/or a non-functional acrylic polymer.

7. The adhesive of claim 1 wherein the polyurethane hot melt comprises a monomeric isocyanate, a polymeric isocyanate or a mixture thereof.

8. An article of manufacture comprising the adhesive of claim 1.

9. The article of claim 8 wherein the polymeric isocyanate in the adhesive is a polymeric MDI.
